(19) United States
(12) Patent Application Publication
(10) Pub. No.: US 2021/0120926 A1
(43) Pub. Date: Apr. 29, 2021

(54) COLLAPSIBLE REUSABLE BAG APPARATUS AND METHODS OF MANUFACTURE THEREOF

(71) Applicant: NEW YORK PACKAGING II, New Hyde Park, NY (US)

(72) Inventor: Jeffrey RABIEA, New Hyde Park, NY (US)

(73) Assignee: NEW YORK PACKAGING II, New Hyde Park, NY (US)

(21) Appl. No.: 16/667,901

(22) Filed: Oct. 29, 2019

(51) Int. Cl. A45C 7/00; B65D 33/10; B65D 33/14

(52) U.S. Cl. CPC A45C 7/0077; B65D 33/14; B65D 33/105

(57) ABSTRACT

A reusable, re-foldable bag with gussets includes a first bag wall; a first side panel; a second side panel; a second bag wall aligned and joined to the first bag wall by the first side panel and the second side panel at a first heat sealed side edge, a second heat sealed side edge, respectively; a bag bottom comprising a substantially planar, foldable surface, the first and the second bag walls, the first and the second side panels, and the bottom formed of a single sheet and together arranged to form a bag defining an opening at a top thereof; a first gusset and a second gusset heat sealed onto the first side panel at the interior of the bag; and a third gusset and a fourth gusset heat sealed onto the second side panel at the interior.

### FIELD

The disclosure relates to pouches or bags. In particular, the disclosure relates to flexible, reusable pouches or bags that are collapsible.

### BACKGROUND

Conventional, single use plastic bags used around the world for shopping have an enormous impact on the environment because they contribute to vast amounts of waste. Yet, single use plastic bags are desired because they are inexpensive, light, and flexible enough to easily conform to goods and fold compactly for packaging, and yet strong enough to support a full load of goods.

Conventional bags, including some reusable bags, may include one or more handles. For example, some bags are made of a non-woven fabric sheet or sheets arranged to form a bag and defining an opening. To ensure adequate strength for both single and repeated uses, sewing is used to seal side and bottom edges, in addition to handle attachment points for convention reusable bags. For example, the top peripheral edge of the conventional bag may include a double-layer portion that is formed by folding down the top portion of the bag at the opening. The double-layer portion is both sewn and bonded by discontinuous ultrasonic sealing. A strip having two ends is attached to the bag to form a handle. Each end of the strip may be arranged to contact the double-layered portion of the bag by an interposing attachment member to provide additional strength. The handle and attachment portion are fastened to the double-layer of the bag by a combination of sewing, heat sealing, and ultrasonic sealing.

Some related art bags include only partial sewing in addition to the heat sealing and ultrasonic sealing. The partial sewing rather than complete sewing minimizes manufacturing costs and time while imparting a bond having a strength sufficient for multiple bag uses.

### SUMMARY

A need has been recognized for bags with handles and having a strength sufficient for multiple while having a thin profile, flexibility, and a manufacturing cost corresponding with costs of, and thus competitive to, conventional single use bags. A bag having flexible profile, a handle, and a strength and durability suitable for multiple, repeated bag uses while having a manufacturing cost and material cost competitive with conventional bags is disclosed. An increasing and unmet demand exists for packaging configured for multiple uses to minimize material waste and environmental impact. Further, a need has been recognized for improved foldability and constructed for precise, repeatable collapsing for storage, and easier and more manageable opening for use. Bag apparatus and methods of manufacture thereof in accordance with embodiments disclosed herein meet these needs and demands.

Bag apparatus and methods of manufacture thereof in accordance with embodiments of the disclosure enable efficient use of packaging materials, minimizing packing costs, maximizing utility, and minimizing environmental impact of disposable bag and pouch usage. Reusable bags in accordance with embodiments of the disclosure are configured for compact folding, and may include a strong, resilient handle pair. Bags of embodiments include a plurality of gusset panels enhancing reusability and foldability. Bags of embodiments may be formed of woven or non-woven material that is suitable for heat and pressure sealing.

In an embodiment, the bag or pouch is formed of suitable material, which may be woven or non-woven. In embodiments, the material comprises polyethylene. For example, the polyethylene may be recycled. In embodiments, the material may comprise polypropylene.

The bags or pouches may be cut and constructed to be any suitable size or shape. By way of example, bag apparatus of an embodiment may be formed to have a width of 18 inches, a length of 17 inches, and a bottom of 6 inches across. In an embodiment, a thickness of the bag lies in a range of thicknesses, measured in units of gram weights, of 30 grams per square meter to 150 grams per square meter, for example. The bag apparatus has handles and is foldable for efficient storage and flexible for conformability to contents.

In an embodiment, a bag apparatus includes a first bag wall; a first side panel; a second side panel; a second bag wall aligned and joined to the first bag wall by the first side panel and the second side panel at a first heat sealed side edge, a second heat sealed side edge, respectively; a bag bottom comprising a substantially planar, foldable surface, the first and the second bag walls, the first and the second side panels, and the bottom formed of a single sheet and together arranged to form a bag defining an opening at a top thereof. The bag includes a first gusset and a second gusset heat sealed onto the first side panel at the interior of the bag. The bag includes a third gusset and a fourth gusset heat sealed onto the second side panel at the interior of the bag.

In an embodiment, the first sealed side edge and the second sealed side edge consist of heat-seals running along an entire length thereof. In an embodiment, the bag includes a first double-layered portion formed in the first bag wall at the top edge and a first width-wise heat seal; and a second double-layered portion formed in the second bag wall at the top edge and a second width-wise heat seal. In an embodiment, the bag includes

In an embodiment, the bag includes a first handle attachment point and a second handle attachment point disposed on the first double-layered portion, wherein a distance between the first attachment point and the second attachment point is five times a height of the first double-layered portion; a third handle attachment point and a fourth handle attachment point disposed on the second double-layered portion, wherein a distance between the third attachment point and the fourth attachment point is five times a height of the second double-layered portion; a first handle attached to the first attachment point and the second attachment point by heat-seal only; and a second handle attached to the third attachment point and the fourth attachment point by heat-seal only.

In an embodiment, the bag includes a first handle attachment point and a second handle attachment point disposed on the first double-layered portion, wherein a distance between the first attachment point and the second attachment point is five times a height of the first double-layered portion; and a third handle attachment point and a fourth handle attachment point disposed on the second double-layered portion, wherein a distance between the third attachment point and the fourth attachment point is five times a height of the second double-layered portion. In an embodiment, the bag includes a first handle attached to the first attachment point and the second attachment point by heat-seal only; and a second handle attached to the third attachment point and the fourth attachment point by heat-seal only.

In an embodiment, the bag includes the bottom, the first wall, and the second wall comprising a flexible material. In an embodiment, the flexible material further includes a thickness lying in a range of thicknesses, measured in units of gram weights, of 30 grams per square meter to 150 grams per square meter. In an embodiment, the material includes polypropylene. In an embodiment, the material includes polyethylene.

In an embodiment, methods of forming a bag in accordance with an embodiment includes providing a planar, flexible sheet comprising a material suitable for heat sealing; folding the sheet and heat sealing to form an open-ended bag having a front, a back, a first side, a second side, and a bottom, wherein the first side and the second side and the bottom are constructed and arranged to be foldable inward in a configuration that causes the bag to naturally collapse into a folded configuration; and forming or attaching a plurality of gussets on an interior of the bag.

In an embodiment, methods include folding top portions of each of the first side portion and the second side portion down onto themselves, and only heat and pressure sealing to form a double layered portion at each of the top portions of the first side portion and second side portion; and joining the first side portion to the second side portion and using only heat and pressure sealing to form two sealed side edges leaving an open top edge, wherein the heat sealing on the double-layered portions intersects the heat sealing on the two side edges.

In an embodiment, methods include attaching handles to attachment points disposed at the double-layered portions of the top edge of the bag, the handles attached only by heat and pressure sealing. In an embodiment, methods include heat-sealing the plurality of gussets to the first side and the second side, respectively, to form gusset seals comprising gusset seams extending along fold lines corresponding with fold lines formed by or for the folding into the folded configuration and an open configuration.

Additional features and technical effects of the present disclosure will become readily apparent to those skilled in the art from the following detailed description wherein embodiments of the present disclosure are described simply by way of illustration of the best mode contemplated to carry out the present disclosure. In addition to the embodiments disclosed herein, other and different embodiments are within the spirit and scope of the disclosure, and its several details are capable of modifications in various respects.

### BRIEF DESCRIPTION OF DRAWINGS

The disclosure is shown by way of example in the figures of the accompanying drawings, in which like reference numerals refer to like elements.

FIG. 1 shows a perspective view of a bag in accordance with an embodiment;

FIG. 2A shows a top view of a bag in accordance with an embodiment;

FIG. 2B shows a bottom view of a bag in accordance with an embodiment;

FIG. 3A shows a front view of a bag in accordance with an embodiment;

FIG. 3B shows a back view of a bag in accordance with an embodiment;

FIG. 4A shows a side view of a bag in accordance with an embodiment;

FIG. 4B shows a side view of a bag in accordance with an embodiment;

FIG. 5A shows a bottom perspective view of a bag in accordance with an embodiment;

FIG. 5B shows a bottom perspective view of a bag in accordance with an embodiment;

FIG. 5C shows a top perspective of a bag in accordance with an embodiment;

FIG. 6 shows a method useful for manufacturing a bag with gusseted sides and in accordance with an embodiment.

### DETAILED DESCRIPTION OF EMBODIMENTS

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

Embodiments of bag apparatus and methods of manufacture thereof are disclosed. Apparatus of embodiments advantageously include handles configured and attached to a reusable bag configured for flexibility and conformability, and formed of any now known or later developed material, including woven or non-woven polymeric material, such as, for example polypropylene, or polyethylene. For the example, the bag wall material may comprise recycled polyethylene. Consumer demand for plastic bags has previously been met by providing thin plastic bags that are flexible, light, and inexpensive, but at the expense of durability and typically configured limited or single use. Recently, consumer demand has increasingly required flexible, thin, and light bags having sufficient strength for multiple uses. Reusable bags with handles and having flexibility, and minimal materials and manufacturing costs are disclosed.

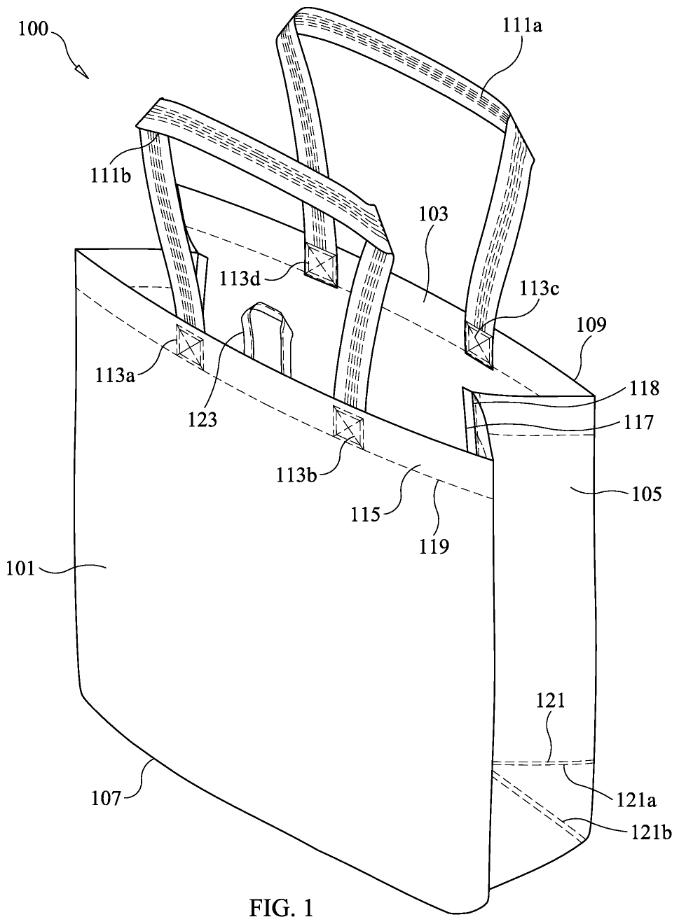

A reusable bag with handles is shown in FIG. 1. In particular, FIG. 1 shows a perspective view of a bag 100 including a first wall 101 aligned and joined to a second wall 103 by at two side panels 105, and a bottom 107, leaving an open unsealed fourth side edge 109. The walls may be formed of any now known or later developed material such as polypropylene and polyethylene. The first wall 101 and the second wall 103 may be formed of the same material, and the sides 105 and the bottom 107 may be formed of the same material as the walls 101 and 103. The sheet material may be clear, colored, or printable, woven or non-woven.

A thickness of the sheets or bag walls may be any useful thickness, and preferably have a thin profile. In some embodiments, a polypropylene fabric bag includes walls and a bottom each having a thickness lying in a range of 0.0002 inches through 0.0040 inches. In some embodiments, a thickness of a polypropylene non-woven bag is selected from a range of thicknesses, measured in units of gram weights, from 30 grams per square meter to 150 grams per square meter.

In embodiments, a bag is formed of a single sheet that is folded and configured to form the first wall 101, the second wall 103, the side panels 105, and the bottom 107. The side panels 105 and the bottom 107 are constructed and arranged to form fold lines along which the side panels 105 and bottom 107. The fold lines or creases are formed to cause the bag to readily collapse into a folded configuration, and to readily expand into an open configuration. The repeatability of the folding and unfolding procedure with accuracy and precision whilst providing useful rigidity in the open configuration and yet a compact folded configuration is enhanced by a gusset heat seal configuration.

In particular, FIG. 1 shows that the sheet forming the bag 100 is formed by joining the first wall 101 and the second wall 103 at side edges 117. A side edge heat seal 118 runs substantially linearly from a top of the side panel 105 to a top of the gusset heat seal 121, above a bottom of the side panel 105. The gusset heat seal 121 may comprise a plurality of heat seal seams, including a first gusset seam 121a and a second gusset seam 121b. The first gusset seam 121a extends from a point at the bottom end of the side edge heat seal 118 to a side edge of the side panel 105. The second gusset seam 121b extends from the point at the side edge heat seal to the side edge of the side panel at a point lower than the first gusset seam 121b. The bag 100 of FIG. 1 includes a second gusset heat seal 122 (not shown) configured similarly the first gusset heat seal 121. The first gusset heat seal 121 and the second gusset heat seal 122 each function to fix a respective gusset layer to an interior of the bag 100. The gusset layer may be formed of a folded-over portion of the same sheet that forms the first wall 101 and the second wall 103. Alternatively, the gusset layers may formed of a separate material fixed to the bag 100 interior by the gusset seals. The gusset layers, alone or combined with the side edge heat seals, the gusset heat seals, enhance accurate and precise bag collapse to a compact collapsed state, and reversible opening into a semi-rigid open bag with a substantially planar bottom.

In another embodiment, gusset layers and corresponding gusset seals may be formed and attached to the bag bottom. A bottom gusset configuration may be used alone, or in combination with a side gusset configuration as shown in FIG. 1.

The side edge heat seal and the gusset heat seals are formed using heat and pressure by any now known or later developed methods suitable for forming a heat seal. No stitching is used. A pair of handles 111a-b separate from the two sheets and attached thereto at handle attachment points 113a-d are configured for carrying the bag. The handles 111a-111d are also heat-sealed to the bag 100.

In an embodiment, the bag wall top edges at the open side 109 of the bag 100 are double-layered. The double-layer portion 115 is formed by folding a portion of each sheet or wall 101 and 103 onto itself during manufacture, and heat-sealing the folded portion from the first side edge 105a to the second side edge 105b. Each of the handles 111a-b may be single-layered, or double-layered, and are attached directly to the bag 100 by the attachment points 113a-d, which are located on the double-layered portion 115. There are no materials or members interposing the handles 111a-b and surfaces at the attachments points 113a-d. It has been found that the combination of heat-sealing only of side and bottom edges and across a width of each of the first wall 101 and the second wall 103, use of the double-layered portion 115 for anchoring attachment points 113a-d, and using only heat-sealing at the attachment points, contribute to durability while accommodating use of flexible, conformable material. The double-layered portion 115 comprises a width-wise heat-seal 119 running across a width of the bag 100 from the first side edge 105a to the second side edge 105b.

The handles are attached to the double-layered portion of the bag at attachment points by heat-sealing using a combination of heat and pressure by well known methods and apparatus. In some embodiments, for example, the height of the double-layered portion is ⅕ of the distance between the attachment points.

Such a handle configuration is shown in FIG. 1. In particular, FIG. 1 shows handles 111a and 111b, each having two ends attached to two attachment points 113a-d located on a double-layered portion 115 at the fourth side 107 of the bag 100. Specifically, a first pair of attachment points 113 are disposed on the first sheet 101, and a second pair of attachment points 113c-d are disposed on the second sheet 103 opposite the first pair of attachment points 113a-b. The height of the double-layered portion 115 may be 30 mm. The distance between the attachments points 113a-b, like the distance between the attachment points 113c-d, may be 150 mm. Thus, the height of the double-layered portion 115 would be ⅕ the distance between attachment points as shown in FIG. 1. This configuration imparts sufficient bag strength for reuse while requiring minimal materials and manufacturing costs by enabling use of heat-sealing processes without costly and time consuming stitching or other sealing methods.

FIG. 1 shows a loop 123 attached to the first side 101 of the bag 100. The loop is configured to handing the bag.

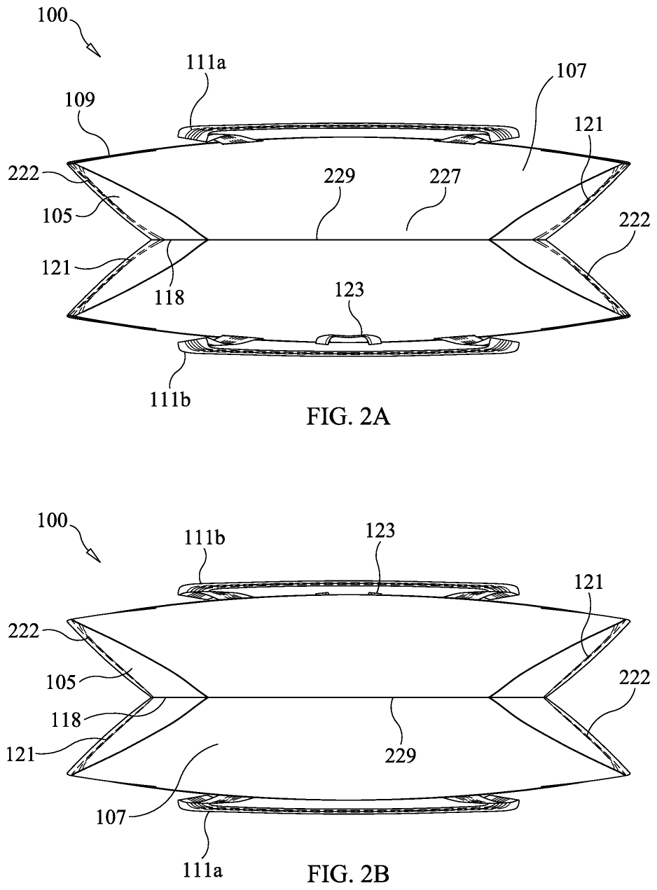

FIG. 2A shows a top view of a bag having handles in accordance with an embodiment. In particular, FIG. 2A shows a top view of a bag 100 including a first wall 101 aligned and joined to a second wall 103 by at two side panels 105, and a bottom 107, leaving an open unsealed fourth side edge 109. Handles 111a and 111b are attached to the bag at attachment points 113a-d disposed on a double-layered portion 115 of the sheet 101 and the sheet 102 of the bag 100. For example, in the embodiment shown in FIG. 2A, the bag 100 includes a hanging loop 123 configured for hanging the bag. The hanging loop may be formed of the same materials as the bag and handle, and may be heat-sealed, stitched, or a combination thereof, to the bag.

FIG. 2A shows a bag interior surface 227. The interior surface 227 bottom is foldable along a fold line 229. Thus, the bag 100 is collapsible for storage, and expandable for use. Additionally, the bottom surface fold configuration avoids a heat-seal seam located directly at the bottom of the bag, thus enhancing strength and durability. Further, the bag 100 includes gusset layers fixed in the interior surface 227 at the side panels 105. In another embodiment, gusset layers may alternatively, or in combination, be disposed on the bag bottom.

In particular, FIG. 2A shows a side edge heat seal 118 that runs substantially linearly from a top of the side panel 105 to a top of a first gusset heat seal 121 and a second gusset seal 222, above a bottom of the side panel 105. The first gusset heat seal 121 may comprise a plurality of heat seal seams, including a first gusset seam 121a and a second gusset seam 121b. The first gusset seam 121a extends from a point at the bottom end of the side edge heat seal 118 to a side edge of the side panel 105. The second gusset seam 121b extends from the point at the side edge heat seal to the side edge of the side panel at a point lower than the first gusset seam 121b. Similarly, the second gusset seal 222 may comprise a plurality of heat seal seams, including a first gusset seam 222a and a second gusset seam 222b. The first gusset heat seal 121 and the second gusset heat seal 122 each function to fix the respective gusset layers (not shown) to an interior of the bag 100.

The gusset layer may be formed of a folded-over portion of the same sheet that forms the first wall 101 and the second wall 103. Alternatively, the gusset layers may formed of a separate material fixed to the bag 100 interior by the gusset seals. The gusset layers alone or combined with the side edge heat seals, the gusset heat seals enhance accurate and precise bag collapse to a compact collapsed state, and reversible opening into a semi-rigid open bag with a substantially planar bottom.

FIG. 2B shows a bottom view of the bag 100 of FIG. 2A. In particular, FIG. 2B shows a first wall 101 aligned and joined to a second wall 103 by at two side panels 105, and a bottom 107, leaving an open unsealed fourth side edge 109. Handles 111a and 111b are attached to the bag at attachment points 113a-d disposed on a double-layered portion 115 of the sheet 101 and the sheet 102 of the bag 100. A crease or fold line 229 is visible on the bottom 107 of the bag 100. Further, the bag 100 includes gusset layers (not shown) fixed in the interior surface 227 at the side panels 105.

FIG. 2B shows a side edge heat seal 118 that runs substantially linearly from a top of the side panel 105 to a top of a first gusset heat seal 121 and a second gusset seal 222, above a bottom of the side panel 105. The bag is configured for repeatable, reversible foldability along the side edge heat seal 118, the first gusset heat seal 121 and the second gusset heat seal 222, and the fold line 229 of the bottom 107. The gusset layers fixed to an interior of the bag by the first gusset seal 121 and the second gusset seal 222 enhance said foldability and re-usability. In another embodiment, gusset layers and corresponding gusset seals may be formed and attached to the bag bottom. A bottom gusset configuration may be used alone or in combination with a side gusset configuration. In an embodiment, a bag includes a bottom and a side gusset configuration.

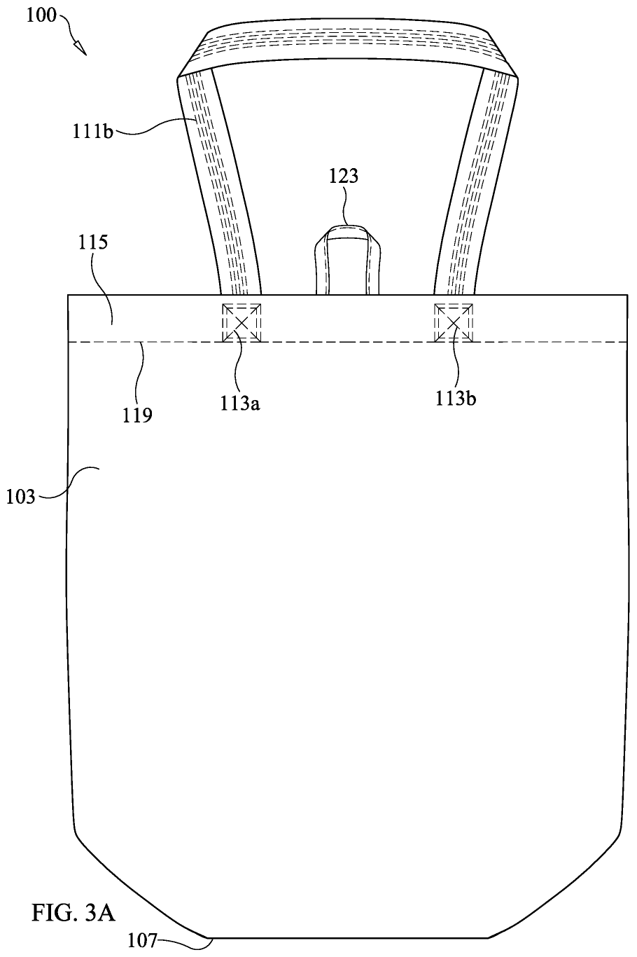

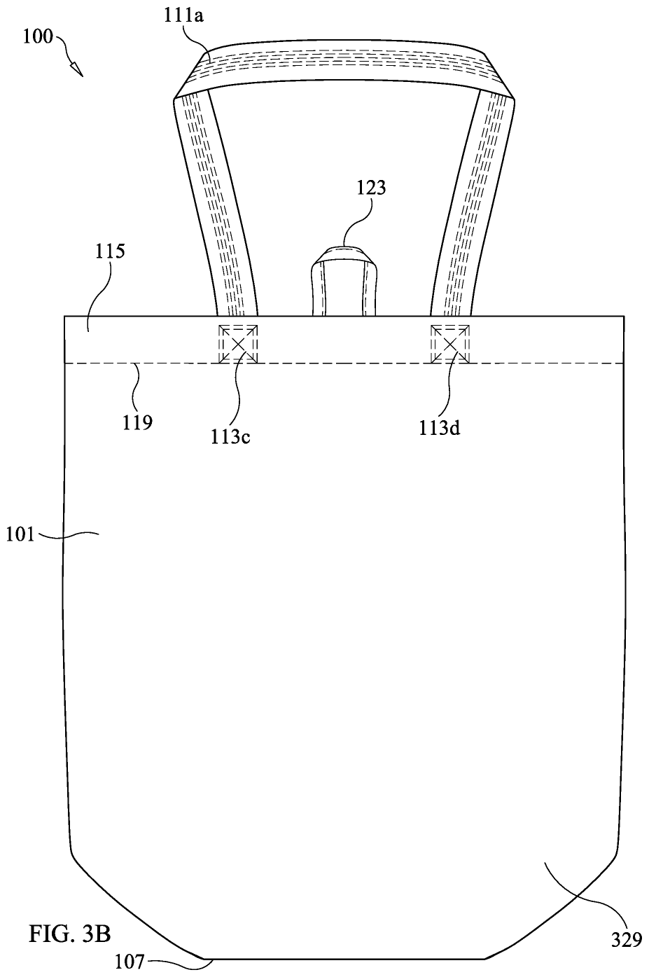

FIG. 3A shows a front view of a bag 100 with handles in accordance with an embodiment. In particular, FIG. 3A shows a bag 100 including a first sheet 101 aligned and joined to a second sheet (not shown) by side panels 105, and a bottom 107, leaving an open unsealed fourth side 109. FIG. 3A shows handles 111a and 111b, each having two ends attached to two attachment points 113a-b located on a double-layered portion 115 at the fourth side 109 of the bag 100. Specifically, a first pair of attachment points 113a-b are disposed on the first sheet 101, and a second pair of attachment points (not shown) are disposed on the second sheet 103 opposite the first pair of attachment points 113a-b. The height of the double-layered portion 115 is shown by way of example in FIG. 1 as 30 mm. The distance between the attachments points 113a-b, like the distance between the attachment points on the second sheet, is 150 mm. Thus, the height of the double-layered portion 115 is ⅕ the distance between attachment points.

FIG. 3A shows curvature between the bottom 107 and the sides of the bag 100. Thus, FIG. 3A shows a view of the bag 100 in a folded configuration. The bag 100 is folded along the fold line (not shown) of the bottom 107, the side edge seals of the side panels 105, and the gusset heat seals of the side panels. The gusset layers, gusset heat seals and lower portion the side panels 105 and sides portions of the bottom 107 are together constructed and arranged to fold the bag corners inward toward a center of the bag 100, resulting in curved or folded corners.

In the embodiment shown in FIG. 3A, the side panels 105 and the double-layered portion 115 comprise a width-wise heat-seal 119 running across a width of the bag 100 from the first side edge 105a to the second side edge 105b. FIG. 2A shows a top view of a bag having handles in accordance with an embodiment. In particular, FIG. 2A shows a top view of a bag 100 including a first wall 101 aligned and joined to a second wall 103 by at two side panels 105, and a bottom 107, leaving an open unsealed fourth side edge 109. Handles 111a and 111b are attached to the bag at attachment points 113a-d disposed on a double-layered portion 115 of the sheet 101 and the sheet 102 of the bag 100.

FIG. 3A shows a loop 123 attached to the first side 101 of the bag 100. The loop 123 is configured for hanging the bag and can be attached by sealing or stitching or a combination thereof.

FIG. 3B shows a rear view of the bag 100 shown in FIG. 3A. FIG. 3B shows attachment points 113c-d. The handle 111b shown in FIG. 3B is attached to the attachment points 113c-d by heat and pressure sealing only.

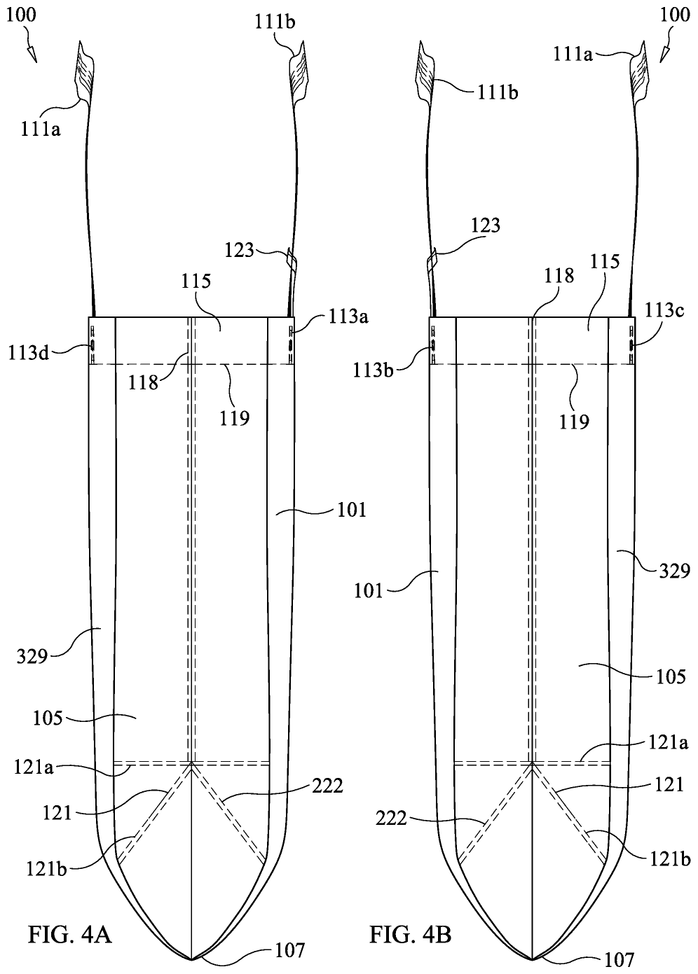

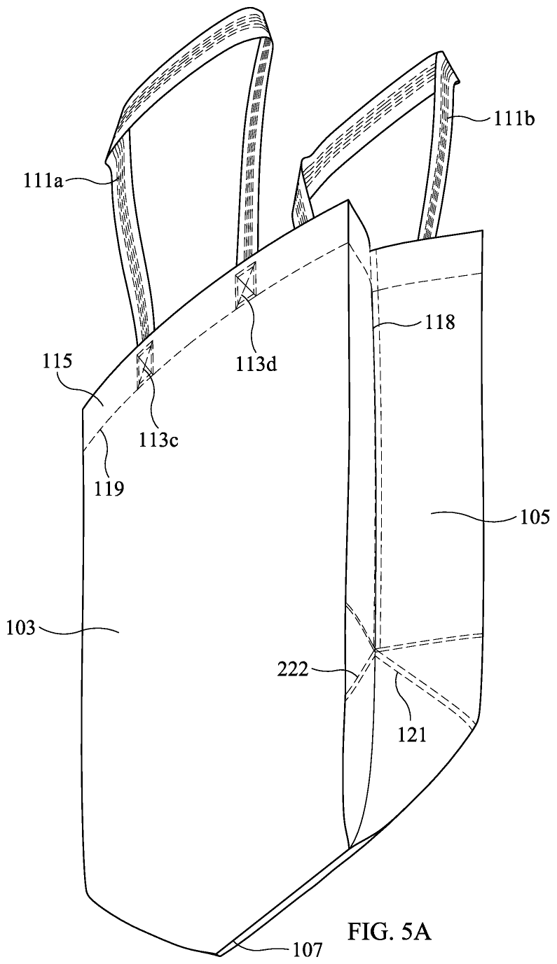

FIGS. 4A-4B shows side views of the bag 100 shown in FIGS. 1-3B. FIGS. 4A-4B show that the bottom 107 of the bag 100 is a reversibly foldable surface that is expandable to form a substantially planar surface. Likewise, the side panels 105 are reversibly foldable along the side seal 118, and gusset seals 121 and 222. FIGS. 4A-4B show the bag 100 in a semi-open or unfolded configuration wherein the side panels 105 are inwardly folded and the gusset layers (not shown) are in some facing relation, interposed by the two folded portions of the side panel 105.

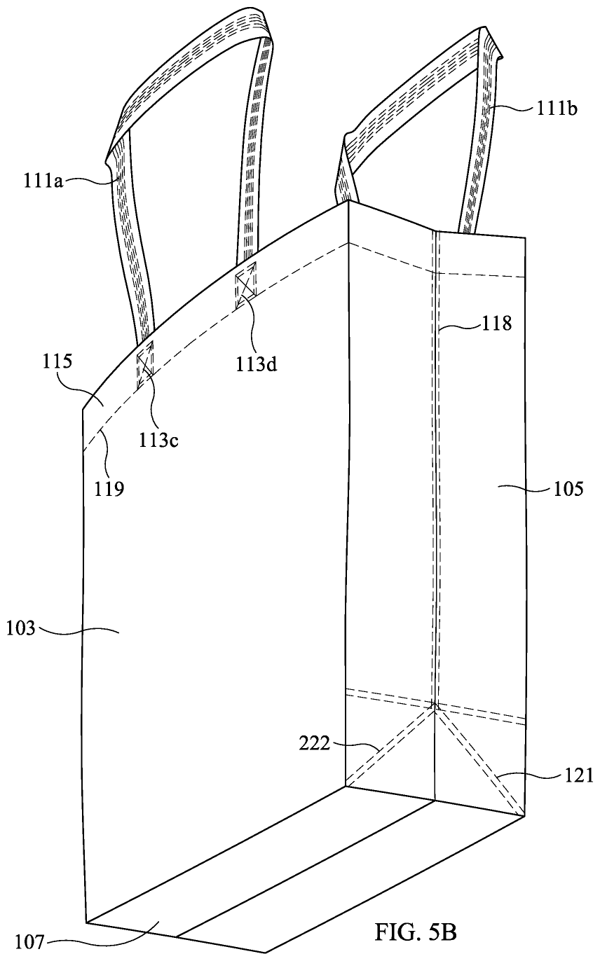

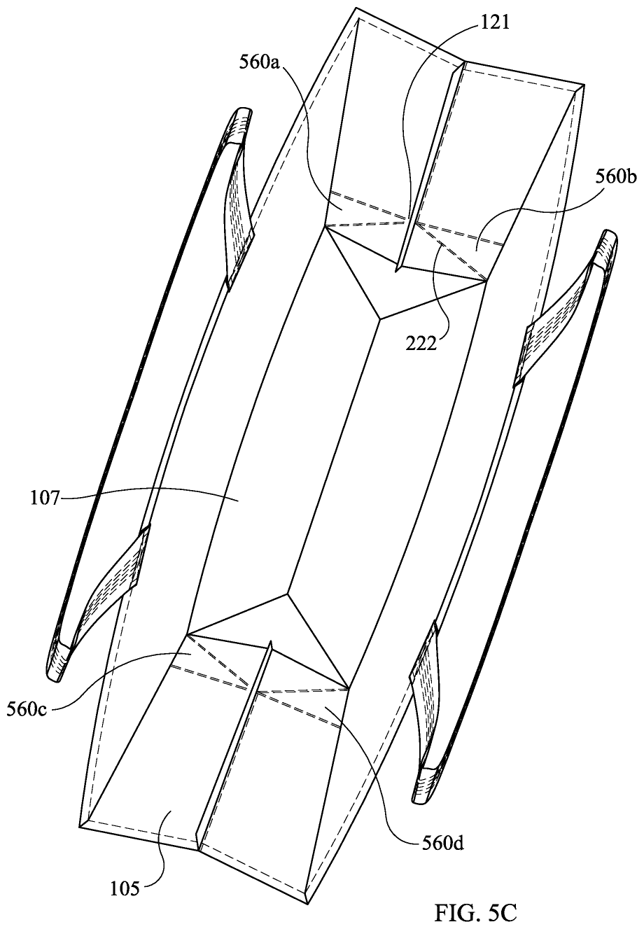

A reusable bag with handles is shown in FIG. 5. In particular, FIG. 5 shows a bottom perspective view of a bag 100 in the semi-open configuration shown in FIGS. 4A-4B. FIG. 5 shows that the bottom is foldable along a fold line 229. Thus, the bag 100 is collapsible for storage, and expandable for use. Additionally, the bottom surface fold configuration avoids a heat-seal seam located directly at the bottom of the bag, thus enhancing strength and durability. Further, the bag 100 includes gusset layers fixed in the interior surface at the side panels 105.

In particular, FIG. 5A shows a side edge heat seal 118 that runs substantially linearly from a top of the side panel 105 to a top of a first gusset heat seal 121 and a second gusset seal 222, above a bottom of the side panel 105. The first gusset heat seal 121 may comprise a plurality of heat seal seams, including a first gusset seam 121a and a second gusset seam 121b. The first gusset seam 121a extends from a point at the bottom end of the side edge heat seal 118 to a side edge of the side panel 105. The second gusset seam 121b extends from the point at the side edge heat seal to the side edge of the side panel at a point lower than the first gusset seam 121b. Similarly, the second gusset seal 222 may comprise a plurality of heat seal seams, including a first gusset seam 222a and a second gusset seam 222b. The first gusset heat seal 121 and the second gusset heat seal 122 each function to fix the respective gusset layers (not shown) to an interior of the bag 100. The gusset layer may be formed of a folded-over portion of the same sheet that forms the first wall 101 and the second wall 103. The gusset layer may have a size and configuration substantially matching the shape outlined by the respect combination of heat seal seams by which the layer is fixed to the bag 100 interior.

The gusset layers provide added rigidity to the portions of the side panels 105 to which the gusset layers are fixed, and enhance the repeatable foldability between open and enclosed configurations, and also provide rigidity and support in an open configuration. In another embodiment, gusset layers and corresponding gusset seals may be formed and attached to the bag bottom. A bottom gusset configuration may be used alone or in combination with a side gusset configuration.

FIG. 5B shows the bag 100 in an open configuration wherein the substantially planar surfaces of the gusset layers extend parallel to a surface of the side panels 105 to which they are fixed at an interior of the bag 100. FIG. 5B shows that in an open configuration, the bottom 107 of the bag 100 includes a substantially planar surface, and that the bottom corners of the first wall 101 and the second wall 103 are shown extended, rather than folded inward toward a center of the bag to cause the appearance of rounded, curved, or folded bottom corners as in the closed or semi-open configurations shown in FIGS. 3A-3B and 4A-4B.

FIG. 5C shows a top perspective view and an interior view of the bag 100 shown in FIGS. 5A-5B. In particular, FIG. 5C shows in an interior of the bag 100 including four gusset layers 560a-560d or panels disposed on the side panels 105 of the bag 100. The four gusset layers 560a-560d are triangular in shape, and configured to enhance folding along a fold configuration that permits ready and repeatable opening and closing. The gusset layers 560a-560d are configured provide rigidity to the side panels 105 at the portions thereof to which the gusset layers 560a-560d are attached. The gusset layers 560a-560d may be formed of folded portions of the material or sheet used to form the side walls 105 and the bottom 107 and entirety of the bag 100. Alternatively, the gusset layers 560a-560d may formed of separate members or pieces fixedly attached to the bag 100 interior at lower portions of the side panels 105 as shown in FIG. 5C.

As shown in FIGS. 5A-5C, the gusset layers 560a-560d are sealed onto the side panels 105 by heating sealing, using a combination of heat and pressure to form seams in the bag material. Heat pressing forms seams using heat to soften the bag material, and pressure to locally deform or alter the material. Thus, portions of the bag material are locally strengthened by a resulting seam, or materials are welded together at a resulting seam. Heat pressing techniques alone are well understood and widely applied in the industry and any now known or later developed suitable methods may be applied to work with embodiments of apparatus and methods disclosed herein. Heat pressing to form seams and to seal bag sides in embodiments of the disclosure enables reduction in parts and reduced manufacturing cost, time, and complexity.

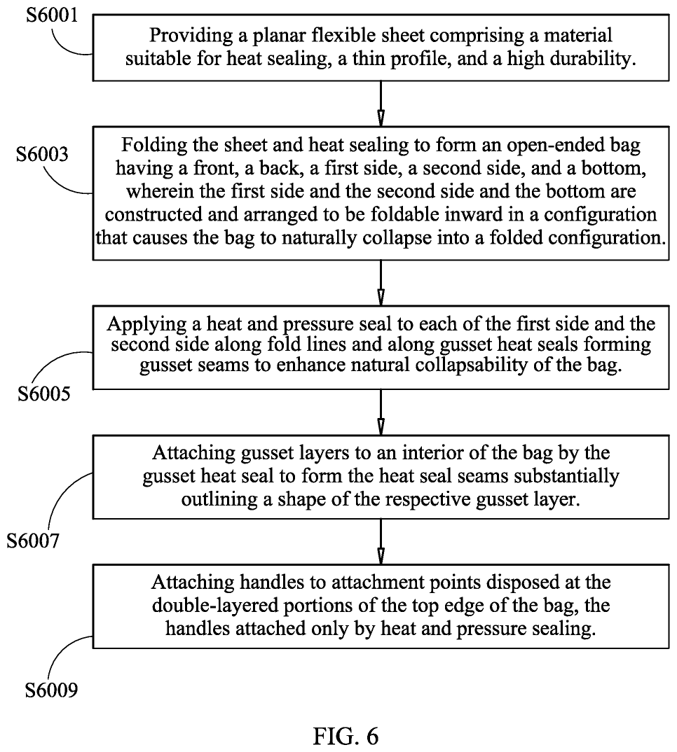

FIG. 6 shows an embodiment of methods useful for manufacturing a bag with gussets as shown in FIGS. 1-5B. In particular, FIG. 6 shows a process 600 including providing a planar, flexible sheet comprising a material suitable for heat sealing at S6001. The material is selected for a thin profile, high durability, flexibility, compactness, and durability sufficient for reuse. The process 600 includes folding the sheet and heat sealing at side edges thereof to form an open-ended bag having a front, a back, a first side, a second side, and a bottom at S6003, wherein the first side and the second side and the bottom are constructed and arranged to be folded inward at portions thereof in a closed configuration.

The folding includes forming fold lines that, in combination with heat sealing along said fold lines, facilitates repeatable opening and closing of the bag. In particular, the process 600 includes applying heat and pressure to form gusset heat seals and side edge heat seals along fold lines at S6005. Further, at S6007, the process 600 includes attaching gusset layers to an interior of the bag, and fixing the gusset layers to the interior of the bag by the gusset heat seals to form heat seal seams substantially outlining a shape of the respective gusset layer fixed thereby. In another embodiment, gusset layers and corresponding gusset seals may be formed and attached to the bag bottom. A bottom gusset configuration may be used alone or in combination with a side gusset configuration. In an embodiment, a bag includes a bottom and a side gusset configuration. Methods may include attaching handles to attachment points at S6009.

Embodiments are shown by way of example, and not by way of limitation in the figures and drawings. While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A bag apparatus, comprising:
a first bag wall;
a first side panel;
a second side panel;
a second bag wall aligned and joined to the first bag wall by the first side panel and the second side panel at a first heat sealed side edge, a second heat sealed side edge, respectively;
a bag bottom comprising a substantially planar, foldable surface, the first and the second bag walls, the first and the second side panels, and the bottom formed of a single sheet and together arranged to form a bag defining an opening at a top thereof;
a first gusset and a second gusset heat sealed onto the first side panel at the interior of the bag; and
a third gusset and a fourth gusset heat sealed onto the second side panel at the interior of the bag.

2. The apparatus of claim 1, the first sealed side edge and the second sealed side edge consisting of heat-seals running along an entire length thereof.

3. The apparatus of claim 1, comprising:
a first double-layered portion formed in the first bag wall at the top edge and comprising a first width-wise heat seal; and
a second double-layered portion formed in the second bag wall at the top edge and comprising a second width-wise heat seal.

4. The apparatus of claim 3, comprising:
a first handle attachment point and a second handle attachment point disposed on the first double-layered portion, wherein a distance between the first attachment point and the second attachment point is five times a height of the first double-layered portion;
a third handle attachment point and a fourth handle attachment point disposed on the second double-layered portion, wherein a distance between the third attachment point and the fourth attachment point is five times a height of the second double-layered portion;
a first handle attached to the first attachment point and the second attachment point by heat-seal only; and
a second handle attached to the third attachment point and the fourth attachment point by heat-seal only.

5. The apparatus of claim 1, comprising:
a hanging loop attached to the first double-layered portion of the first wall.

6. The apparatus of claim 5, comprising:
a first handle attachment point and a second handle attachment point disposed on the first double-layered portion, wherein a distance between the first attachment point and the second attachment point is five times a height of the first double-layered portion;
and
a third handle attachment point and a fourth handle attachment point disposed on the second double-layered portion, wherein a distance between the third attachment point and the fourth attachment point is five times a height of the second double-layered portion.

7. The apparatus of claim 6, comprising:
a first handle attached to the first attachment point and the second attachment point by heat-seal only; and
a second handle attached to the third attachment point and the fourth attachment point by heat-seal only.

8. The apparatus of claim 6, comprising:
a hanging loop stitched to the first wall at the first double-layered portion thereof.

9. The apparatus of claim 6, the bottom, the first wall, and the second wall comprising a flexible material.

10. The apparatus of claim 9, the flexible material further comprising a thickness in a range of thicknesses, measured in units of gram weights, of 30 grams per square meter to 150 grams per square meter.

11. The apparatus of claim 1, the material further comprising polypropylene.

12. The apparatus of claim 1, the material further comprising polyethylene.

13. A method of forming a bag, comprising:
providing a planar, flexible sheet comprising a material suitable for heat sealing;
folding the sheet and heat sealing to form an open-ended bag having a front, a back, a first side, a second side, and a bottom, wherein the first side and the second side and the bottom are constructed and arranged to be foldable inward in a configuration that causes the bag to naturally collapse into a folded configuration; and
forming or attaching a plurality of gussets on an interior of the bag.

14. The method of claim 14, comprising:
folding top portions of each of the first side portion and the second side portion down onto themselves, and only heat and pressure sealing to form a double layered portion at each of the top portions of the first side portion and second side portion; and
joining the first side portion to the second side portion and using only heat and pressure sealing to form two sealed side edges leaving an open top edge, wherein the heat sealing on the double-layered portions intersects the heat sealing on the two side edges.

15. The method of claim 15, comprising:
attaching handles to attachment points disposed at the double-layered portions of the top edge of the bag, the handles attached only by heat and pressure sealing.

16. The method of claim 1, the material further comprising polypropylene.

17. The method of claim 1, the material further comprising polyethylene.

18. The method of claim 1, the bag comprising a thickness in a range of thicknesses, measured in units of gram weights, of 30 grams per square meter to 150 grams per square meter.

19. The method of claim 1, comprising:
heat-sealing the plurality of gussets to the first side and the second side, respectively, to form gusset seals comprising gusset seams extending along fold lines corresponding with fold lines formed by or for the folding into the folded configuration and an open configuration.

20. The method of claim 14, the plurality of gussets comprising four gussets disposed the bag bottom, and four gussets disposed on the bag sides.
